(19) United States
(12) Patent Application Publication
(10) Pub. No.: US 2008/0164133 A1
(43) Pub. Date: Jul. 10, 2008

(54) Dome-Shaped Contact and Multi-Step Operation Electrical Switch Incorporating the Same

(75) Inventor: Isao Hayafune, Saitama (JP)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Japan Aviation Electronice Industry Limited, Tokyo (JP)

(21) Appl. No.: 10/575,957

(22) PCT Filed: Jun. 7, 2005
(86) PCT No.: PCT/JP2005/010393

§ 371 Date: Apr. 14, 2006

(30) Foreign Application Priority Data
Jun. 15, 2004 (JP) 2004-177070

(51) Int. Cl. H01H 13/14

(52) U.S. Cl. 200/516

(57) ABSTRACT

The present invention relates to a multi-step operation electrical switch having an elastic conductive plate, which is deformed to establish an electrical contact when a pressing force is applied thereto and is restored to the initial state to break the electrical contact when the pressing force is removed.

According to the present invention, the elastic plate has a plurality of dome portions formed integrally therewith, each of the dome portions bulges in the direction opposite to the direction in which the elastic plate is pressed and is depressed by the pressing force applied thereto. The applied pressing force varies with the dome portions. In order to prevent an electrical contact from being established when no pressing force is applied to the elastic plate, spacer portions are necessary. According to the present invention, inclined spacer portions are provided along the outer peripheries of a first and a second dome portions, respectively.

Therefore, since the pressing force is temporarily reduced when one dome portion is depressed, a click feel can be provided. Since the pressing force varies with the dome portions, a multi-step operation can be achieved. In addition, since the elastic plate has a plurality of dome portions and a plurality of spacer portions formed integrally therewith, the overall size of the switch can be readily miniaturized.

### TECHNICAL FIELD

The present invention relates to a dome-shaped contact that provides a multi-step operation, in particular, a two-step operation and an electrical switch incorporating the same.

### BACKGROUND ART

FIGS. 1A to 1D show components of a switch described in the patent literature 1 as a conventional example of such a two-step operation switch. In this example, the switch comprises a contact forming component 10, a legged movable plate 20 and a domed sheet 30 housed in the contact forming component 10, and a cover 40 placed over these components.

The contact forming component 10 comprises a resin mold 11 and a switch plate, which constitutes a switch contact, is insert-molded in the resin mold 11. At the bottom of a circular center part of a recess 12, there are disposed and exposed a circular switch contact 13 and an arch-shaped switch contact 14 surrounding the circular switch contact 13. In addition, at the bottom of the edges of straight line-shaped parts of the recess 12 located on the opposite sides thereof, switch contacts 15 and 16 (the contact 16 cannot be seen in the drawing) are disposed and exposed. The end portions of the switch plates constituting the switch contacts 13 to 16 are drawn from the opposite sides of the resin mold 11 to constitute terminal portions 13a to 16a.

The legged movable plate 20 is made of an elastic metal and comprises a disk-like main body 21 and two legs 22 protruding from the outer periphery of the main body 21. The main body 21 has a dome-shaped portion bulging upward. The middle area of the underside of the dome-shaped portion constitutes a contact portion 23, and the underside of the peripheral part of the dome-shaped portion constitutes a contact portion 24. Each leg 22 protruding from the main body 21 is approximately T-shaped, and the ends of the T-shaped leg 22 are bent slightly downward to form contact portions 25.

The domed sheet 30 is made of resin and has a dome portion 31 bulging upward in the middle thereof.

The cover 40 is made of metal plate and has a circular through-hole 41 formed in the middle thereof, opposite two edges 42 of the cover 40 are bent downward, and an engaging opening 43 is formed in each of the bent edges 42. Each engaging opening 43 is engaged with an engaging claw 17 on the resin mold 11 of the contact forming component 10.

FIG. 2A shows a cross-sectional structure of the switch in an assembled state. The contact portions 25 of the two legs 22 of the legged movable plate 20 are located on and in contact with the switch contacts 15 and 16. And the contact portions 23 and 24 of the two legs 22 of the legged movable plate 20 face the switch contacts 13 and 14 at predetermined distances. The switch contacts 15 and 16 are always electrically connected to each other.

When the dome portion 31 of the domed sheet 30 of the switch constructed as described above is pressed by a finger or an actuator 50, the dome portion 31 is deformed and depressed, which provides a click feel, to press the legged movable plate 20, thereby deforming the two legs 22 to lower the main body 21 with the shape kept unchanged, bringing the peripheral contact portion 24 into contact with the switch contact 14. FIG. 2B shows the dome-shaped contact in this state. In this state, the switch contacts 15 and 16 the switch contact 14 are electrically connected to each other.

As the dome portion 31 is further pressed, the main body 21 of the legged movable plate 20 is deformed and depressed to provide a click feel, and the contact portion 23 at the middle of the main body 21 comes into contact with the switch contact 13, as shown in FIG. 2C. Thus, all the switch contacts 13 to 16 are electrically connected to each other.

When the force pressing the dome portion 31 is removed, the legged movable plate 20 and the dome portion 31 are restored to the initial state. That is, the switch returns to the state shown in FIG. 2A.

### Patent Literature 1: Japanese Patent Application Laid-Open No. 10-112240

### DISCLOSURE OF THE INVENTION

### Issues to be Solved by the Invention

The conventional switch described above and shown in FIGS. 1A to 1D and 2A to 2C achieves a two-step switching operation by two actions of the legged movable plate 20 including deformation of the legs 22 and deformation of the main body 21. The tactile response (click feel) involved with a first-step switching operation is provided by depression of the dome portion 31 of the domed sheet 30, and the tactile response involved with a second-step switching operation is provided by depression of the dome-shaped portion of the main body 21 of the legged movable plate 20. In other words, separate two components are required to provide two tactile responses.

Furthermore, since the legged movable plate 20 has the two legs 22 that protrude significantly from the main body 21, the size of the whole legged movable plate 20 is large, and accordingly, miniaturization of the switch is difficult.

In view of such problems, an object of the present invention is to provide a multi-step operation electrical switch that can provide a clear two-step tactile response by itself and can be readily miniaturized.

### Means to Solve Issues

The present invention relates to a multi-step operation electrical switch having an elastic conductive plate, which is deformed to establish an electrical contact when a pressing force is applied thereto and is restored to the initial state to break the electrical contact when the pressing force is removed. According to the present invention, the elastic plate has a plurality of dome portions formed integrally therewith, each of the dome portions bulges in the direction opposite to the direction in which the elastic plate is pressed and is depressed by the pressing force applied thereto. The force required to depress each dome portion is different for each dome portion. In order to prevent an electrical contact from being established when no pressing force is applied to the elastic plate, spacer portions are necessary. According to the present invention, inclined spacer portions are provided along the outer peripheries of a first and a second dome portions, respectively.

### EFFECTS OF THE INVENTION

Since the pressing force is temporarily reduced when one dome portion is depressed according to the present invention, a click feel can be provided. Since the pressing force varies with the dome portions, a multi-step operation can be achieved. In addition, since the elastic plate has a plurality of dome portions and a plurality of spacer portions formed integrally therewith, the overall size of the switch can be readily miniaturized. Furthermore, since the first and second dome portions have the respective inclined portions (spacer portions) along the outer peripheries thereof, and the inclined portions support the dome portions at the outer peripheries thereof, a restoration failure can be prevented, and thus, a stable operation can be achieved in that respect.

### BRIEF DESCRIPTION OF THE DRAWINGS

FIG. 1A is an exploded perspective view showing a cover of a conventional switch that provides a two-step operation (a two-step push switch);

FIG. 1B is an exploded perspective view showing a domed sheet of the conventional two-step push switch;

FIG. 1C is an exploded perspective view showing a legged movable plate of the conventional two-step push switch;

FIG. 1D is an exploded perspective view showing a contact forming component of the conventional two-step push switch;

FIG. 2A is a cross-sectional view of the two-step push switch shown in FIG. 1 in an initial state;

FIG. 2B is a cross-sectional view of the two-step push switch shown in FIG. 1 whose first contact is in contact with a switch contact;

FIG. 2C is a cross-sectional view of the two-step push switch shown in FIG. 1 whose second contact is in contact with a switch contact;

FIG. 3A is a plan view of a dome-shaped contact according to the present invention;

FIG. 3B is a cross-sectional view of the dome-shaped contact according to the present invention;

FIG. 3C is a perspective view of the dome-shaped contact according to the present invention;

FIG. 4 is a diagram showing an example of fixed contacts disposed facing the dome-shaped contact;

FIG. 5A is a cross-sectional view of a multi-step operation electrical switch whose dome-shaped contact is not pressed;

FIG. 5B is a cross-sectional view of the multi-step operation electrical switch whose first dome portion is depressed;

FIG. 5C is a cross-sectional view of the multi-step operation electrical switch whose second dome portion is depressed;

FIG. 6 is a graph showing a relationship between the stroke and the pressing force when pressing an elastic plate;

FIG. 7A is a plan view showing an exemplary configuration of the dome-shaped contact in which two openings are formed in the first dome portion;

FIG. 7B is a plan view showing an exemplary configuration of the dome-shaped contact in which four openings are formed in the first dome portion;

FIG. 7C is a plan view showing an exemplary configuration of the dome-shaped contact in which eight openings are formed in the first dome portion;

FIG. 7D is a plan view showing an exemplary configuration of the dome-shaped contact in which eighteen openings are formed in the first dome portion;

FIG. 8A is a cross-sectional view showing a case where a protrusion 67 extending in the direction opposite to the direction in which the second dome portion 64 bulges is formed on the inner surface of the second dome portion 64;

FIG. 8B is a cross-sectional view showing a case where a foreign body 75 having got into the dome-shaped contact exists on a fixed contact 73;

FIG. 9A is a plan view showing a case where one protrusion 67 is formed at the center of the second dome portion 64;

FIG. 9B is a cross-sectional view showing a case where one protrusion 67 is formed at the center of the second dome portion 64;

FIG. 9C is an enlarged cross-sectional view of the protrusion 67;

FIG. 10 is a plan view sowing a case where three protrusions 67 are formed on the second dome portion 64;

FIG. 11A is a plan view of the dome-shaped contact 60 in which a protrusion 69 is formed on the first dome portion 61, a protrusion 67 is formed on the second dome portion, and a part of the first spacer portion 62 is cut out;

FIG. 11B is a side view of the dome-shaped contact 60 in which the protrusion 69 is formed on the first dome portion 61, and a part of the first spacer portion 62 is cut out;

FIG. 11C is a cross-sectional view of the dome-shaped contact 60 in which the protrusion 69 is formed on the first dome portion 61, and a part of the first spacer portion 62 is cut out;

FIG. 11D is an enlarged cross-sectional view of the protrusion 69;

FIG. 12A is a plan view of the dome-shaped contact 60 in which five protrusions 69 are formed;

FIG. 12B is a plan view of the dome-shaped contact 60 in which six protrusions 69 are formed;

FIG. 12C is a plan view of the dome-shaped contact 60 in which eight protrusions 69 are formed;

FIG. 12D is a plan view of the dome-shaped contact 60 in which ten protrusions 69 are formed;

FIG. 13A shows an example of wiring on the circuit board in which wires are disposed on the surface of the circuit board and extend from the fixed contacts 72 and 73 in the same direction;

FIG. 13B shows an example of wiring on the circuit board in which wires are disposed on the surface of the circuit board and extend from the fixed contacts 72 and 73 in the opposite directions;

FIG. 14 is a cross-sectional view showing a structure of a cut 81 and the vicinity thereof;

FIG. 15 is a cross-sectional view showing the protrusion 69 in contact with the fixed contact 72;

FIG. 16A is a plan view of the dome-shaped contact 60 in which an opening 68 is formed in the first dome portion 61, and a part of the edge of the opening 68 is bent toward the inside of the dome-shaped contact 60 to form a contact portion 69-2;

FIG. 16B is a side view of the dome-shaped contact 60 in which an opening 68 is formed in the first dome portion 61, and a part of the edge of the opening 68 is bent toward the inside of the dome-shaped contact 60 to form a contact portion 69-2;

FIG. 16C is a cross-sectional view of the dome-shaped contact 60 in which an opening 68 is formed in the first dome portion 61, and a part of the edge of the opening 68 is bent toward the inside of the dome-shaped contact 60 to form a contact portion 69-2;

FIG. 17 is a cross-sectional view showing the contact portion 69-2 in contact with the fixed contact 72 in the case where the inclination of the contact portion 69-2 is equal to that of the second spacer portion 63;

FIG. 18 is a cross-sectional view showing the contact portion 69-2 in contact with the fixed contact 72 in the case where the inclination of the contact portion 69-2 is greater than that of the second spacer portion 63;

FIG. 19 is a plan view showing the circuit board 70 shown in FIG. 13B covered with the dome-shaped contact 60 shown in FIG. 16A;

FIG. 20A is a cross-sectional view showing a structure of the multi-step operation electrical switch in which an air release opening 79 is formed in the circuit board 70;

FIG. 20B is a cross-sectional view showing a structure of the multi-step operation electrical switch in which an air release opening 91 is formed in a fixing sheet 90;

FIG. 20C is a cross-sectional view showing a structure of the multi-step operation electrical switch in which an air release opening 79 is formed in the circuit board 70, and the fixing sheet is provided with a cushion material 92; and

FIG. 20D is a cross-sectional view showing a structure of the multi-step operation electrical switch in which an air release opening 91 is formed in the fixing sheet 90, and the fixing sheet is provided with a cushion material 92.

### BEST MODES FOR CARRYING OUT THE INVENTION

Embodiments of the present invention will be described with reference to the drawings.

### First Embodiment

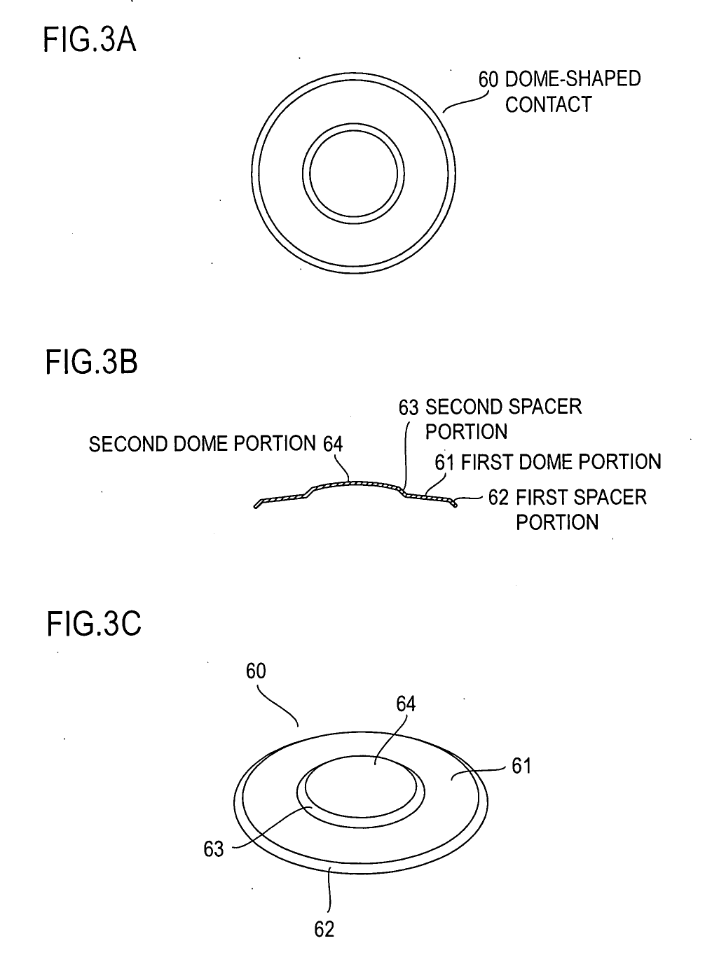

FIGS. 3A to 3C show an embodiment of dome-shaped contact used in a multi-step operation electrical switch according to the present invention. According to this embodiment, a dome-shaped contact 60 is formed by press-working an elastic metal plate, comprises a first dome portion 61, a first spacer portion 62 formed along the outer periphery of the first dome portion 61, a second dome portion 64 formed at the center of the first dome portion 61 with a second spacer portion 63 interposed between the first dome portion 61 the second dome portion 64, and has a circular contour as a whole. For example, a spring stainless steel plate is used for the elastic metal plate forming the dome-shaped contact 60. In addition, to achieve higher conductivity, at least areas of the underside of the dome portions 61 and 64 in which contact portions 65 and 66 are to be formed may be plated with Ni, or Ag and Ni. The metal used for plating is not limited to these metals, and other metals can be used for plating. Furthermore, the elastic plate may not be a metal one. For example, an elastic nonconductive plate may be formed into the shape of the dome-shaped contact 60 and then coated with conductive films at areas that are to be in contact with electrodes.

The first dome portion 61 and the second dome portion 64, which are curved in the shape of a dome, bulge in the same direction, and the radius of curvature of the second dome portion 64 is smaller than that of the first dome portion 61.

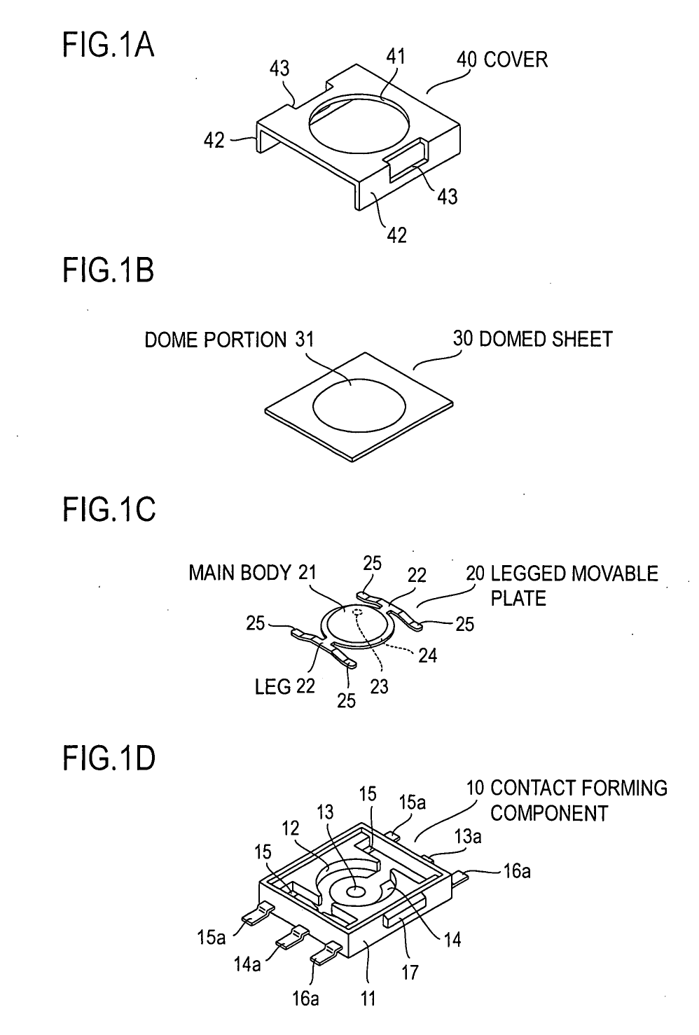

The first spacer portion 62 and the second spacer portion 63 are both conical and are tapered in the direction in which the dome portions 61 and 64 bulge. As can be seen from the cross-sectional view of FIG. 1B, the spacer portions 62 and 63 are rectilinear, while the dome portions 61 and 64 are curved.

Now, an operation of the dome-shaped contact 60 having the structure described above will be described.

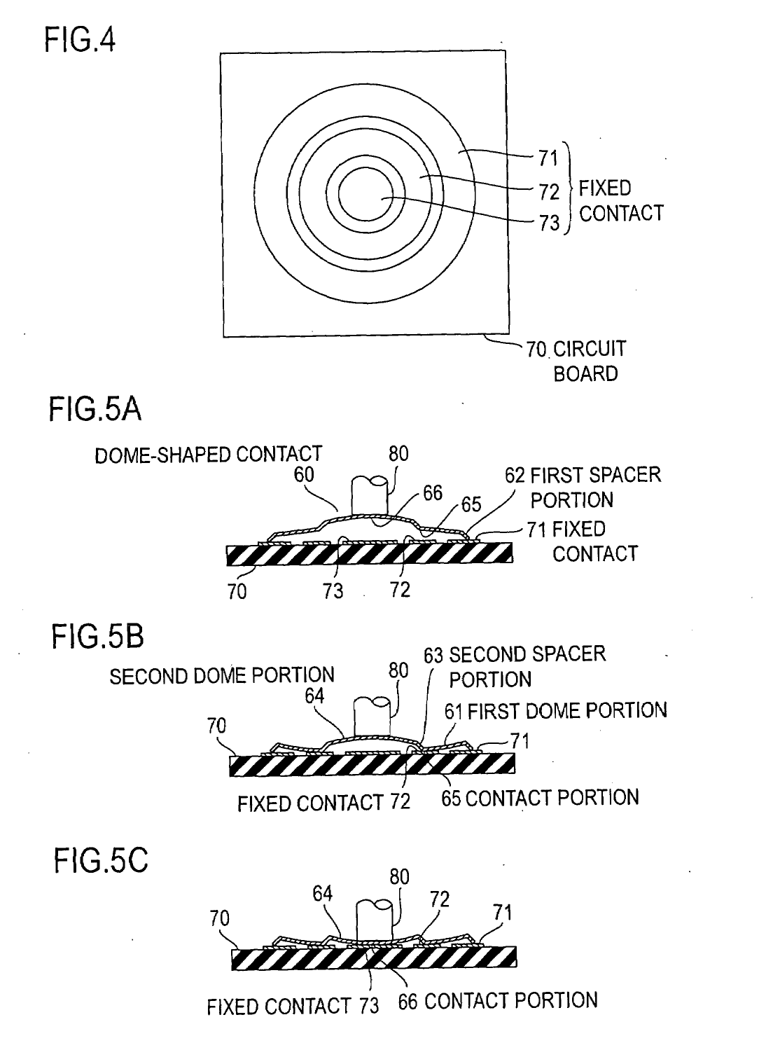

FIG. 4 shows an example of fixed contacts disposed facing the dome-shaped contact 60 that functions as a movable contact. Three fixed contacts 71 to 73 are formed on a circuit board 70. The fixed contact 73 is a circular one, the fixed contact 72 is an annular one disposed surrounding the fixed contact 73, and the fixed contact 71 is also an annular one disposed surrounding the fixed contact 72.

FIG. 5A shows the dome-shaped contact 60 disposed on the circuit board 70. The outer periphery of the dome-shaped contact 60 is located on the fixed contact 71, and the first spacer portion 62 is in contact with the fixed contact 71.

For example, the second dome portion 64 of the dome-shaped contact 60 is pressed by means of an actuator 80. If the radius of curvature of the first dome portion 61 is larger than that of the second dome portion 64, the first dome portion 61 is more likely to be deformed than the second dome portion 64. Then, the first dome portion 61 is first deformed and depressed. When the first dome portion 61 is depressed, the boundary portion between the first dome portion 61 and the second spacer portion 63 (that is, the contact portion 65) comes into contact with the fixed contact 72, as shown in FIG. 5B. Thus, the fixed contacts 71 and 72 are connected to each other, and a first-step switching operation is achieved.

As the second dome portion 64 is pressed further, then the second dome portion 64 is depressed, and the center area of the inner surface of the dome portion 64 (that is, the contact portion 66) comes into contact with the fixed contact 73, as shown in FIG. 5C. Thus, the fixed contacts 71 and 73 are connected to each other, and a second-step switching operation is achieved.

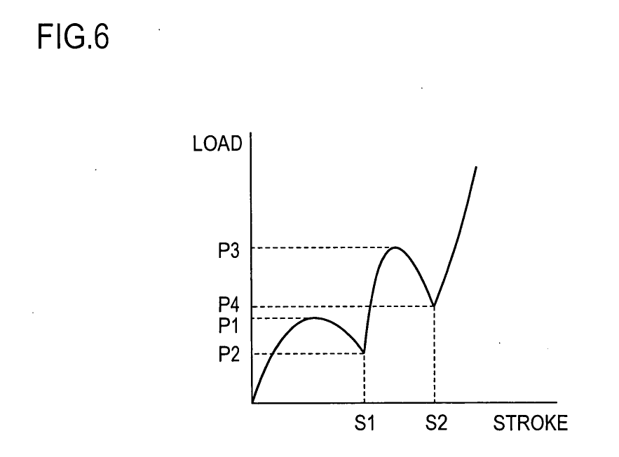

FIG. 6 shows a relationship between the stroke of pressing of the second dome portion 64 and the load placed on the second dome portion 64 during pressing. When the stroke reaches a point S1, the first dome portion comes into contact with the fixed contact 72. When the stroke reaches a point S2, the second dome portion comes into contact with the fixed contact 73. Extreme load values P1 and P3 represent loads that make the first dome portion 61 and the second dome portion 64 be depressed, respectively. Load values P2 and P4 represent loads placed on the second dome portion 64 when the first dome portion comes into contact with the fixed contact 72 and when the second dome portion comes into contact with the fixed contact 73, respectively. The difference between the loads P1 and P2 and the difference between the loads P3 and P4 make a user feel a click.

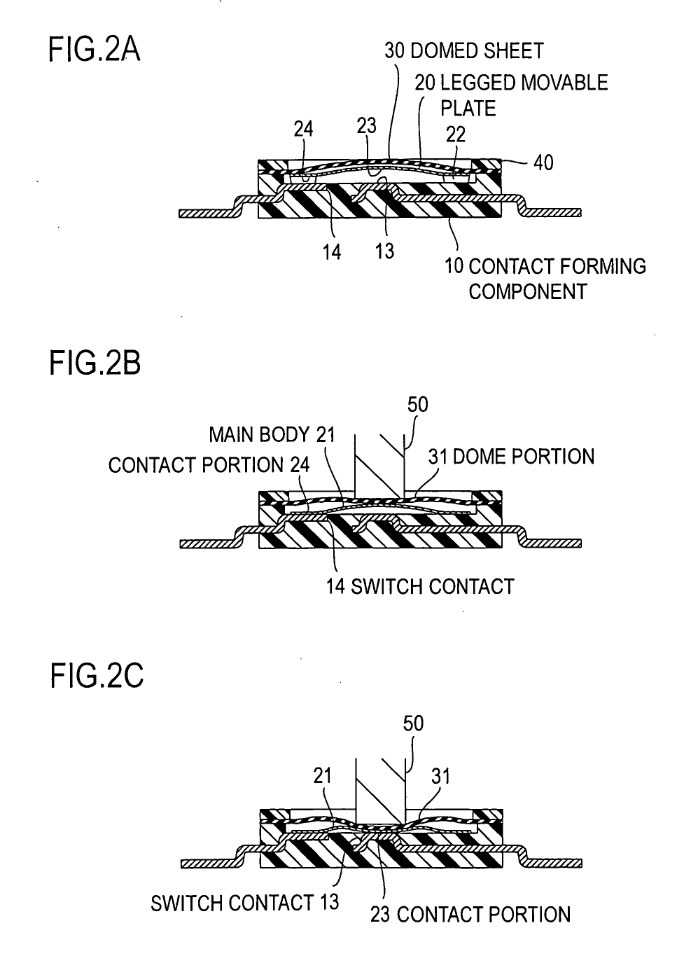

As described above, according to this embodiment, the first and second-step switching operations are achieved by depressing the first dome portion 61 and the second dome portion 64, respectively, and both provide a clear click feel. That is, the dome-shaped contact 60 can provide a clear two-step click feel by itself. Therefore, compared with the conventional switch that uses two components to provide a two-step click feel shown in FIGS. 1A to 1D and 2A to 2C, the number of components can be reduced, and the fabrication cost can be reduced.

The dome-shaped contact 60 is formed by press-working an elastic metal plate and has a significantly simple outside shape compared with the conventional legged movable plate 20 shown in FIG. 1C. Therefore, the dome-shaped contact 60 can be readily reduced in thickness or size. Thus, the dome-shaped contact is suitable as a switch contact (movable contact) of a shutter switch in a cellular phone, a digital camera or the like, for example.

If the force pressing the second dome portion 64 is removed, the dome portions 61 and 64 are restored from the depressed state to the state shown in FIG. 5A due to the elastic restoring force. According to this embodiment, the inclined spacer portions 62 and 63 are disposed along the outer peripheries of the first dome portion 61 and the second dome portion 64, respectively. The dome portions 61 and 64 are supported at the outer peripheries by the spacer portions 62 and 63, respectively, which are inclined straight lines in cross section. Therefore, the dome portions 61 and 64 are restored from the depressed state with reliability, and a restoration failure, which is a phenomenon in which any dome portion is not restored from the depressed state when the pressing force is removed, is hard to occur. In this way, a stable operation can be achieved.

Such a dome-shaped contact, which has the first dome portion, the second dome portion, the first spacer portion and the second spacer portion united with each other, can provide a clear two-step click feel by itself and allows fabrication of a multi-step operation electrical switch that can be readily miniaturized. As specific examples, the outer diameter R of the spacer portion 62 may be 5 mm, and the outer diameter r of the spacer portion 63 may be 2.5 mm. In addition, if the diameter R falls within a range of R≧5 mm, and the ratio of the diameter r to the diameter R falls within a range of 0.4≦r/R≦0.6, a clear click feel and a reliable two-step operation can be expected.

### Second Embodiment

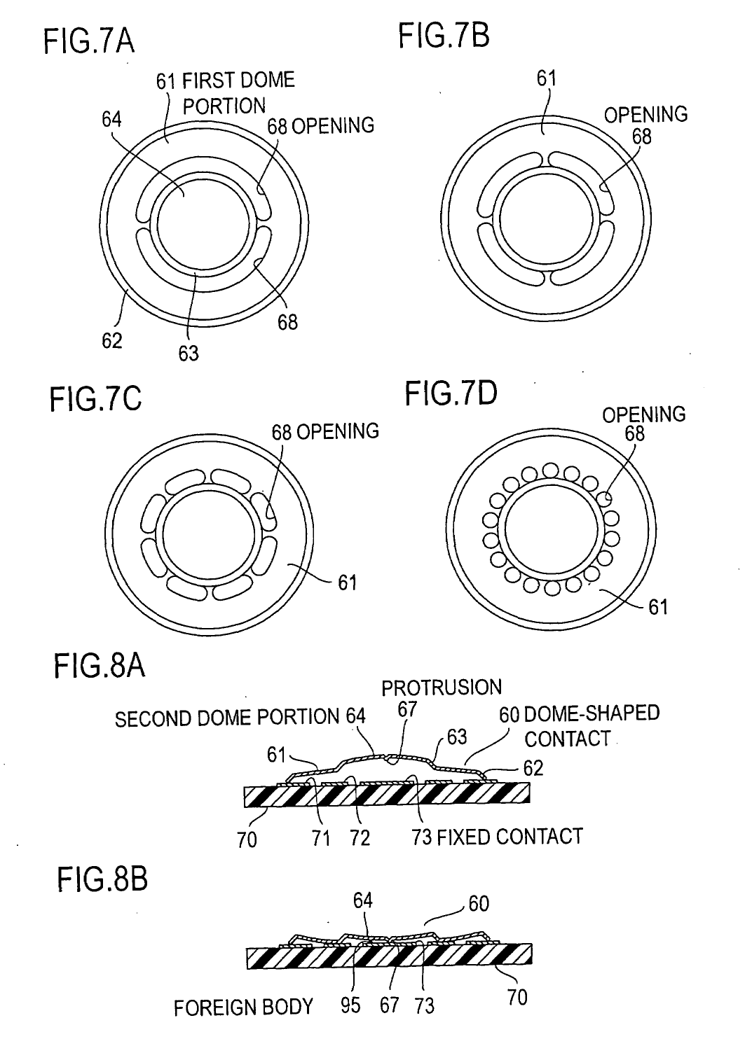

An embodiment shown in FIGS. 7A to 7D will be described. According to this embodiment, a plurality of openings 68 are formed in the first dome portion 61 in order that the pressing force during the first-step switching operation is reduced, and the first dome portion 61 can be deformed and depressed with a smaller load. Referring to FIG. 7A, two approximately semicircular-arch-shaped openings 68 are formed along the inner periphery of the first dome portion 61. Similarly, referring to FIGS. 5B and 5C, four and eight arch-shaped openings 68 are arranged and formed along the inner periphery of the dome portion 61, respectively. Referring to FIG. 5D, eighteen circular openings 68 are arranged and formed along the inner periphery of the dome portion 61.

The number of openings 68 can be appropriately determined as shown in FIGS. 7A to 7D. However, in terms of stability of the second dome portion 64, the configuration shown in FIG. 5B, in which the second dome portion 64 is supported on two axes, is preferably adopted, for example.

These openings 68 serve to reduce the load P1 shown in FIG. 6 and thus allow adjustment of the click feel provided by the difference between the loads P1 and P2. It is difficult to explicitly specify the optimum size or number of the openings, because the thickness of the elastic plate, the diameter of the dome-shaped contact or the like has to be taken into consideration. However, this approach is effective in final adjustment of the click feel.

In the case where the outer diameter R of the spacer portion 62 is 5 mm, and the outer diameter r of the spacer portion 63 is 2.5 mm as in the first embodiment, the minimum size (diameter or width) of the openings is about 0.2 mm in terms of workability, and a suitable size is about 0.3 mm.

### Third Embodiment

FIG. 8A shows an example of the present invention, in which a protrusion 67 extending in the direction opposite to the direction in which the second dome portion 64 bulge is formed at the center of the second dome portion 64. If the protrusion 67 is formed on the surface facing the fixed contact 73 in this way and used as a contact portion to come into contact with the fixed contact 73, the contact reliability can be improved.

FIG. 8B shows a state in which a foreign body 75 having got into the dome-shaped contact 60 exists on the fixed contact 73 for illustration. Even if such a foreign body 75 gets into the dome-shaped contact 60, the protrusion 67 can ensure the contact (electrical connection) between the second dome portion 64 and the fixed contact 73. While one protrusion 67 is formed in this embodiment, a plurality of protrusions 67 may be formed near the center of the dome portion 64.

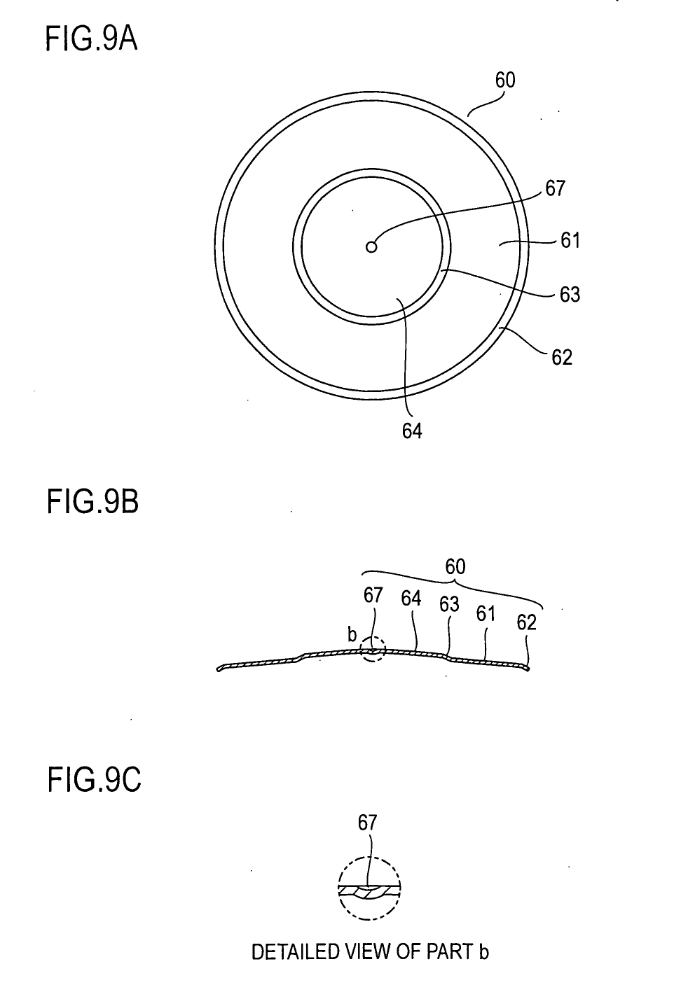

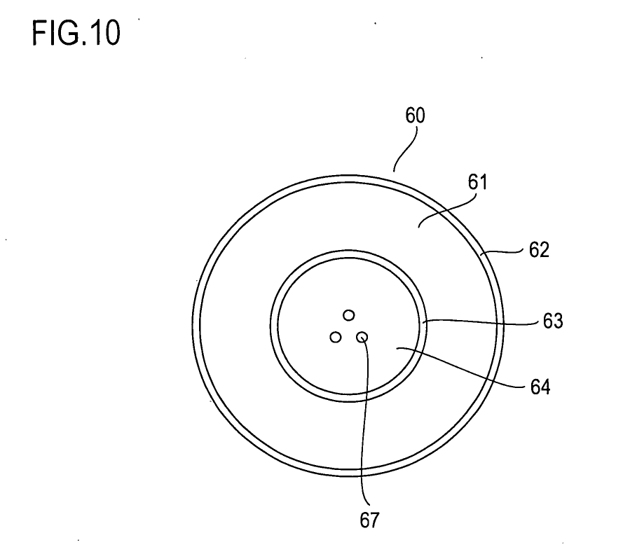

FIG. 9A is a plan view of the dome-shaped contact 60 with one protrusion 67 formed at the center of the second dome portion 64, FIG. 9B is a cross-sectional view thereof, and FIG. 9C is an enlarged cross-sectional view of the protrusion 67. FIG. 10 is a plan view of the dome-shaped contact 60 with three protrusions 67 formed on the second dome portion 64.

The height of the protrusion 67 can be 20 μm to 100 μm, taking into consideration the size of actual foreign bodies 75.

### Fourth Embodiment

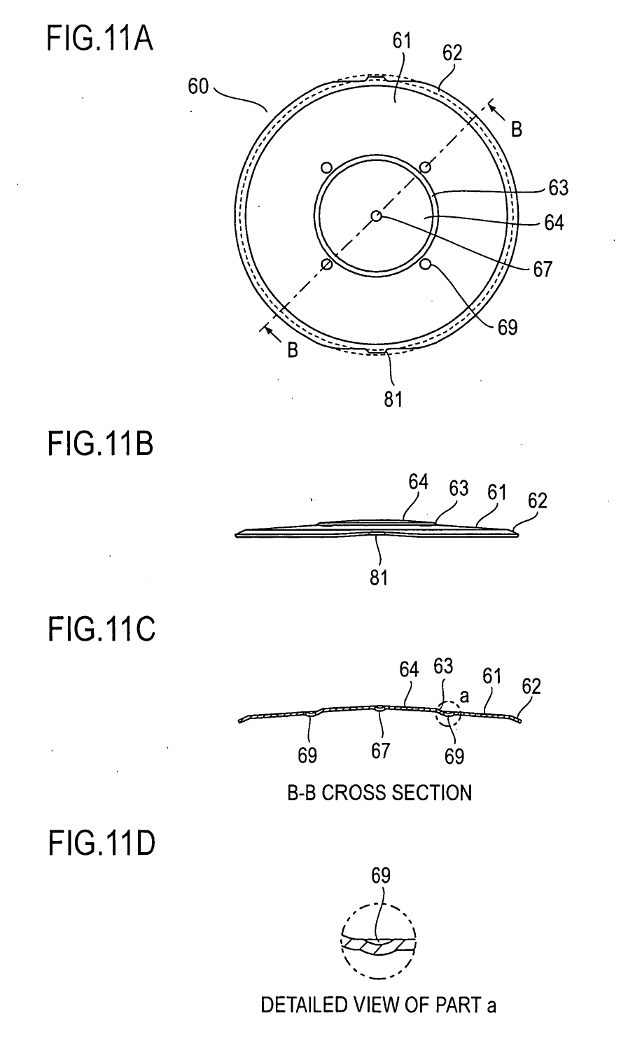

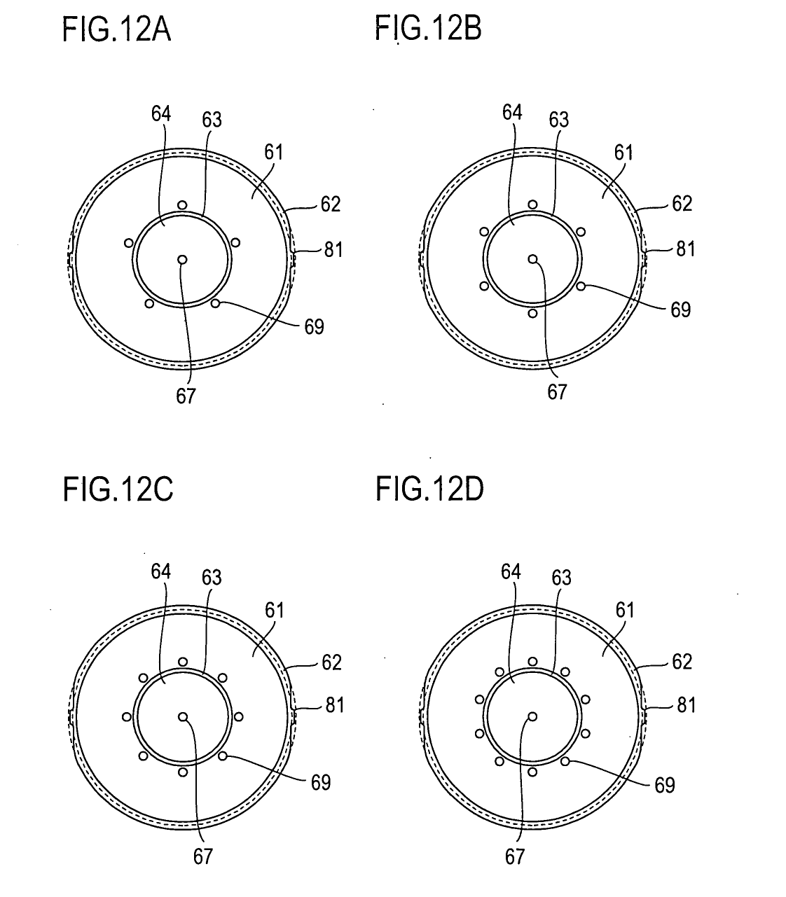

FIGS. 11A to 11D show the dome-shaped contact 60 in which a protrusion 69 is formed on the first dome portion 61, and a cut is formed in the first spacer portion 62. FIG. 12A is a plan view of the dome-shaped contact 60 with five protrusions 69, FIG. 12B is a plan view of the dome-shaped contact 60 with six protrusions 69, FIG. 12C is a plan view of the dome-shaped contact 60 with eight protrusions 69, and FIG. 12D is a plan view of the dome-shaped contact 60 with ten protrusions 69. Cuts 81 shown in FIGS. 11A and 12A to 12D are provided to dispose wires extending from the fixed contacts 72 and 73 on the surface of the circuit board. The protrusion 69 is formed to ensure the contact between the fixed contact 72 and the first dome portion 61, as with the protrusion 67.

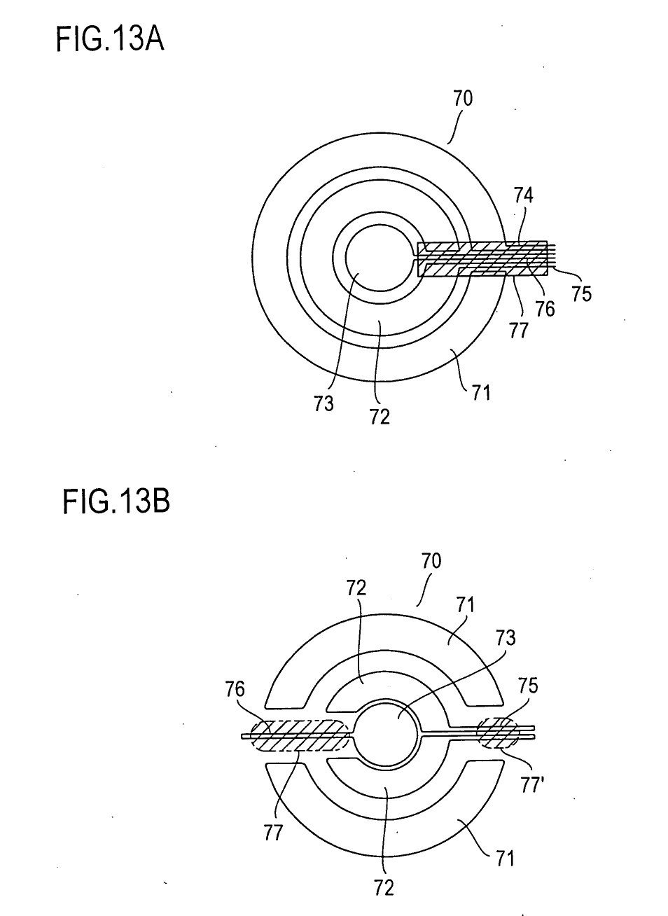

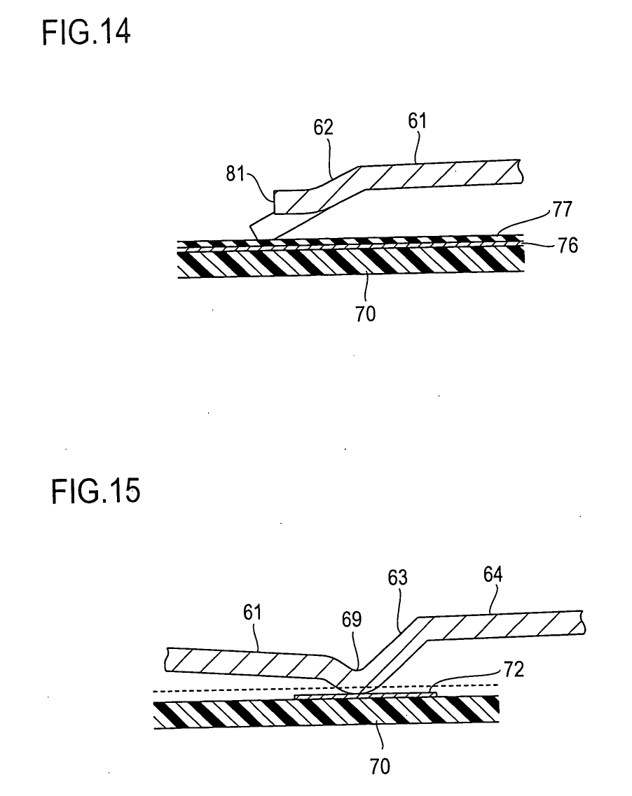

FIGS. 13A and 13B show examples of wiring on the circuit board in the case where wires extending from the fixed contacts 72 and 73 are disposed on the surface of the circuit board. Reference numeral 75 denotes a wire extending from the fixed contact 72, and reference numeral 76 denotes a wire extending from the fixed contact 73. The surface of the wires 75 and 76 are covered with an insulating film 77. FIG. 14 is a cross-sectional view showing a structure of the cut 81 and the vicinity thereof. The wire 76 is disposed on the surface of the circuit board 70 and covered with the insulating film 77. Since a part of the spacer portion 62 is cut out to form the cut 81, the wire 76 disposed on the surface of the circuit board 70 is drawn to the outside of the dome-shaped contact 60 without coming into contact with the dome-shaped contact 60.

If the cut 81 is formed, and the wires 75 and 76 are disposed on the surface of the circuit board in this way, a multi-step operation electrical switch can be provided using only one side of the circuit board 70. This not only enhances the degree of flexibility of design and manufacture of the multi-step operation electrical switch but also is highly advantageous for cost reduction.

If the outer diameter R of the spacer portion 62 is 5 mm, and the outer diameter r of the spacer portion 63 is 2.5 mm as in the first embodiment, the width of the insulating film 77 is 0.7 mm, and the width of the cut is 1.6 mm. The height of the cut 81 may be only two to six times greater than the total thickness of the wire 75 or 76 and the insulating film 77.

FIG. 15 is a cross-sectional view showing the protrusion 69 in contact with the fixed contact 72. As with the protrusion 67 described with regard to the third embodiment, the protrusion 69 is formed to ensure the electrical contact even when a foreign body gets into the multi-step operation electrical switch. The height of the protrusion 69 is 20 μm to 100 μm, as with the protrusion 67.

### Fifth Embodiment

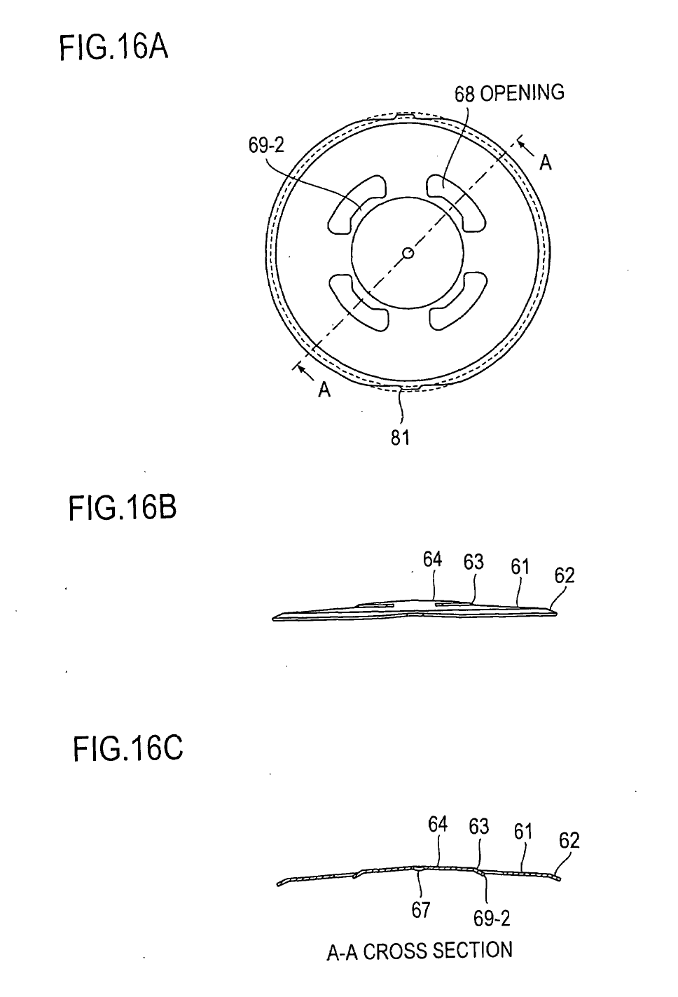

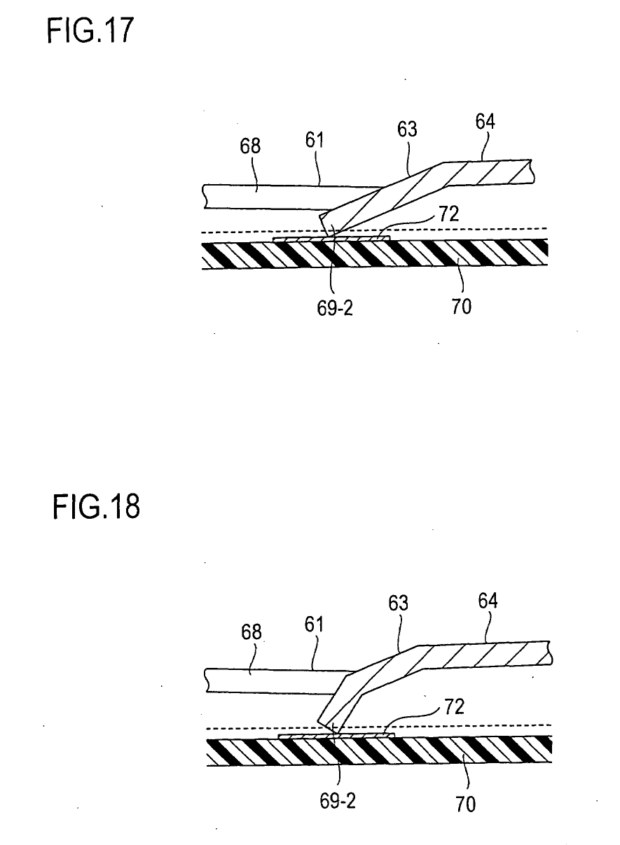

FIGS. 16A to 16C show the dome-shaped contact 60 in which a part of the edge of the opening 68 formed in the first dome portion 61 is bent toward the inside of the dome-shaped contact 60 to form a contact portion 69-2, and a part of the first spacer portion 62 is cut out. FIG. 16A is a plan view, FIG. 16B is a side view and FIG. 16C is a cross-sectional view. FIG. 17 is a cross-sectional view showing the contact portion 69-2 in contact with the fixed contact 72 in the case where the inclination of the contact portion 69-2 is equal to that of the second spacer portion 63. FIG. 18 is a cross-sectional view showing the contact portion 69-2 in contact with the fixed contact 72 in the case where the inclination of the contact portion 69-2 is greater than that of the second spacer portion 63.

In the case where the outer diameter R of the spacer portion 62 is 5 mm, and the outer diameter r of the spacer portion 63 is 2.5 mm as in the first embodiment, the minimum size (diameter or width) of the opening 68 is about 0.2 mm in terms of workability, and a suitable size is about 0.3 mm. The width of the insulating film 77 is 0.7 mm, and the width of the cut is 1.6 mm. The height of the cut 81 may be only two to six times greater than the total thickness of the wire 75 or 76 and the insulating film 77. The height of the contact portion 69-2 (or the length of the protrusion extending into the dome-shaped contact 60) is 20 μm to 100 μm, as with the protrusion 69.

By forming such an opening 68, the load P2 can be adjusted as described with regard to the second embodiment. In addition, since the cut 81 is formed as in the fourth embodiment, the wire 76 disposed on the surface of the circuit board 70 can be drawn to the outside of the dome-shaped contact 60 without coming into contact with the dome-shaped contact 60.

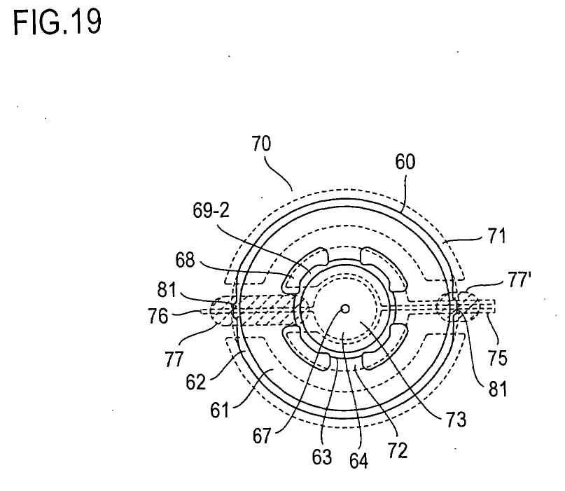

FIG. 19 is a plan view showing the circuit board 70 shown in FIG. 13B covered with the dome-shaped contact 60 shown in FIG. 16A. The fixed electrodes 71, 72 and 73, the wires 75 and 76 and the like on the circuit board 70 are indicated by dotted lines. In this drawing, it can be seen that the wires 75 and 76 are drawn to the outside of the dome-shaped contact 60 through the two cuts 81.

### Sixth Embodiment

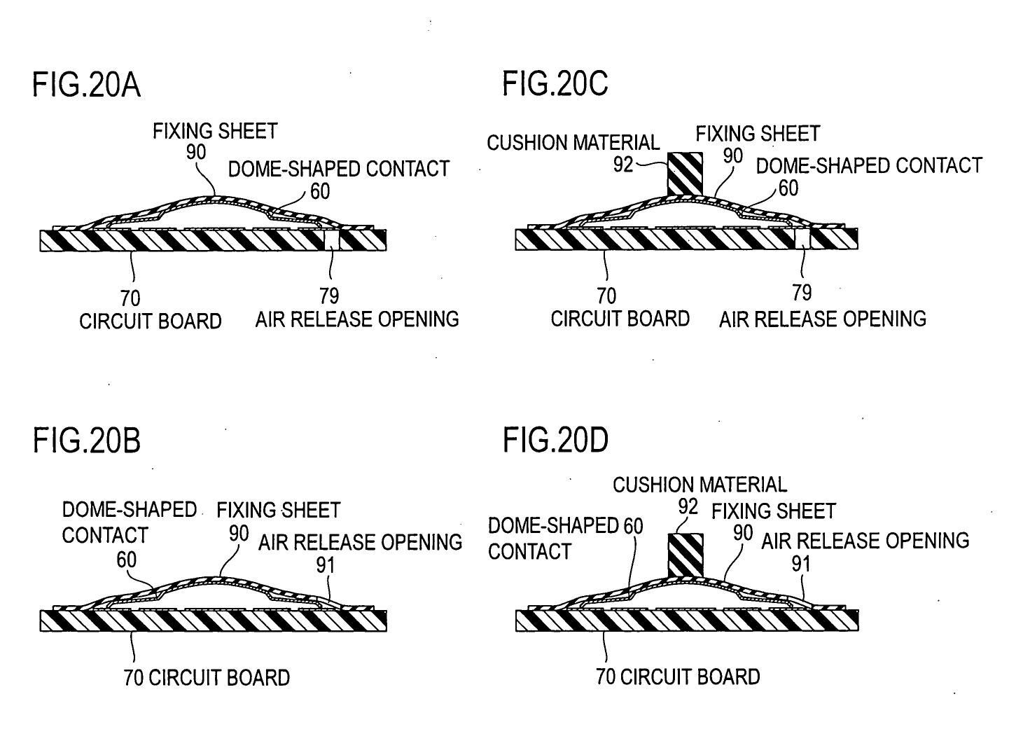

FIGS. 20A to 20D are cross-sectional views showing a structure of a multi-step operation electrical switch. The dome-shaped contact 60 is disposed on the circuit board 70 and fixed thereto by a fixing sheet 90. FIG. 20A shows a case where an air release opening 79 is formed in the circuit board 70. FIG. 20B shows a case where an air release opening 91 is formed in the fixing sheet 90. FIG. 20C shows a case where an air release opening 79 is formed in the circuit board 70, and the fixing sheet is provided with a cushion material 92. FIG. 20D shows a case where an air release opening 91 is formed in the fixing sheet 90, and the fixing sheet is provided with a cushion material 92.

When the multi-step operation electrical switch is pressed, the air in the switch has to be released to the outside. To this end, the air release opening 79 or 91 is formed in the circuit board 70 or the fixing sheet 90.

The circuit board 70 is not always located close to the outer sheath of the product (a cellular phone, a digital camera or the like) incorporating the multi-step operation electrical switch. In general, there is a gap between the portion of the product pressed by a user's finger and the circuit board 70. Thus, the cushion material 92 is provided to fill the gap between the part pressed by the user's finger and the circuit board 70.

1. A dome-shaped contact composed of an elastic conductive plate, comprising:
a first dome portion;
a first spacer portion that is disposed along the outer periphery of said first dome portion; and
a second dome portion that is disposed at the center of said first dome portion with a second spacer portion interposed between the first and second dome portions;
wherein said first dome portion and said second dome portion bulge in the same direction,
said first and second spacer portions are both conical and tapered in said bulge direction, and
the radius of curvature of said second dome portion is smaller than the radius of curvature of said first dome portion.

2. The dome-shaped contact of claim 1, wherein said second dome portion has a protrusion that extends in the direction opposite to said bulge direction.

3. The dome-shaped contact of claim 2, wherein at least a surface of said elastic plate facing in the direction opposite to said bulge direction is plated with Ni or with Ag and Ni.

4. The dome-shaped contact of claim 1, wherein said first dome portion has a plurality of openings.

5. The dome-shaped contact of claim 1, wherein, supposing that the outer diameter of said first spacer portion is denoted by R, and the outer diameter of said second spacer portion is denoted by r, the ratio r/R falls within a range of 0.4≦r/R≦0.6.

6. A multi-step operation electrical switch having a contact formed on a board and a dome-shaped elastic conductive plate, comprising:
a first dome portion;
a first spacer portion that is disposed along the outer periphery of said first dome portion;
a second dome portion that is disposed at the center of said first dome portion with a second spacer portion interposed between the first and second dome portions;
a first contact that faces the first dome portion; and
a second contact that faces the second dome portion,
wherein said first dome portion and said second dome portion bulge in the same direction,
said first and second spacer portions are both conical and tapered in said bulge direction, and
the radius of curvature of said second dome portion is smaller than the radius of curvature of said first dome portion.

7. A multi-step operation electrical switch having a contact formed on a board and a dome-shaped elastic conductive plate, said elastic plate being deformed to come into electrical contact with said contact when the elastic plate is pressed, and said elastic plate being restored to the initial shape and electrically disconnected from said contact when a pressing force is removed, the multi-step operation electrical switch comprising:
a first dome portion that is a part of said elastic plate, bulges in the direction opposite to the direction in which the elastic plate is pressed, and is depressed by a pressing force applied thereto;
a first contact that is formed on the board and comes into contact with said first dome portion when the first dome portion is depressed;
a first spacer portion that is a part of said elastic plate and serves to maintain a clearance between the first dome portion and the first contact when said first dome portion is not depressed;
a second dome portion that is a part of said elastic plate, bulges in the direction opposite to the direction in which the elastic plate is pressed, and is depressed by a pressing force that is greater than the pressing force applied to depress said first dome portion;
a second contact that is formed on the board and comes into contact with said second dome portion when the second dome portion is depressed; and
a second spacer portion that is a part of said elastic plate and serves to maintain a clearance between the second dome portion and the second contact when said first dome portion is depressed but said second dome portion is not depressed.

8. The multi-step operation electrical switch of claim 7, wherein a protrusion is formed on the inner surface of said first dome portion, the protrusion extending in the direction opposite to the direction in which the first dome portion bulges and coming into contact with the first contact when the first dome portion is depressed.

9. The multi-step operation electrical switch of claim 7, wherein an opening is formed in said first dome portion, and a part of the edge of the opening is bent in the direction opposite to the direction in which the first dome portion bulges to form a protrusion that comes into contact with the first contact when the first dome portion is depressed.

10. The multi-step operation electrical switch of claim 7, wherein a protrusion is formed on the inner surface of said second dome portion, the protrusion extending in the direction opposite to the direction in which the second dome portion bulges and coming into contact with the second contact when the second dome portion is depressed.

11. The multi-step operation electrical switch of any one of claims 8 to 10, wherein at least a part of said protrusion that comes into contact with the contact is plated with Ni or with Ag and Ni.

12. The multi-step operation electrical switch of claim 7, wherein said first spacer portion has a cut for drawing out either or both of wires extending from said first contact and said second contact.

13. The multi-step operation electrical switch of claim 7, wherein said elastic plate is fixed by a sheet covering the elastic plate, and
an air release opening is formed in said board or said sheet.

14. The multi-step operation electrical switch of claim 7, wherein, supposing that the outer diameter of the first spacer portion is denoted by R, and the outer diameter of the second spacer portion is denoted by r, the ratio r/R falls within a range of 0.4≦r/R≦0.6.
